(19) United States
(12) Patent Application Publication
(10) Pub. No.: US 2004/0088250 A1
(43) Pub. Date: May 6, 2004

(54) Subscriber account replenishment in a netework-based electronic commerce system incorporating prepaid service offerings

(76) Inventors: William Dale Bartter, Gahanna, OH (US); Yigang Cai, Naperville, IL (US); Mark Raymond Locher, Dublin, OH (US); Brian Robertson Rae, Bristol (GB); Allan Terry Rush, Glendale, AZ (US); Sridhar Sripathi, Columbus, OH (US)

Correspondence Address: Docket Administrator (Room 3J-219), Lucent Technologies Inc., 101 Crawfords Corner Road, Holmdel, NJ, 07733-3030, US

(21) Appl. No.: 10/284,679

(22) Filed: Oct. 31, 2002

(51) Int. Cl. G06F 17/60

(52) U.S. Cl. 705/39

(57) ABSTRACT

Methods are disclosed for replenishing subscriber accounts in an intelligent network-based e-commerce system 100 using credit/debit cards (FIG. 2) or scratch cards (FIG. 3). An end user sends a recharge request to a client application 108-120. The recharge includes information comprising the recharge amount, an identifier of the prepaid account, and indicia of one the credit card, debit card or scratch card for funding the recharge amount. The client application forwards the information to a gateway server 104 which, in turn, sends the information to a service control point (SCP) 122. In the embodiment using a credit/debit card, the SCP determines validity of the account and authorization to fund the recharge amount using the credit/debit card. In the embodiment using a scratch card, the SCP determines validity of the account and validity of the scratch card. Validity of the scratch card is determined by querying a recharge card management system (RCMS). If the transaction is successful, the SCP credits the recharge amount to the prepaid account and sends an acknowledgment to the gateway server. If the transaction is unsuccessful, the SCP sends an error message or negative acknowledgment to the gateway server. The gateway server forwards the information to the client application and the client application informs the end user of the outcome.

### FIELD OF THE INVENTION

This invention relates generally to the field of electronic commerce (or “e-commerce) and, more particularly, to an intelligent network-based e-commerce system that incorporates prepaid service offerings.

### CROSS REFERENCE TO RELATED APPLICATIONS

This application is related to the following applications filed concurrently with the present application, assigned to the assignee of the present invention and incorporated herein by reference in their entirety: Bartter 1-20-2-1-1-1 and Bartter 3-22-4-3-3-3.

### BACKGROUND OF THE INVENTION

Communication networks such as the Internet are known to interconnect communication devices spanning a large geographical area. Generally, the Internet (sometimes referred to as the World Wide Web) is a combination of local area networks (LANs) and wide area networks (WANs) that speak the same protocols (e.g., TCP/IP protocol), thereby allowing a variety of communication devices connected to the Internet to communicate with each other. For example, communication devices including without limitation, computers, cell phones, wireline phones, pagers, two-way radios, personal digital assistants (PDAs) and the like may be connected to the network, using access technologies such as Ethernet, telephone wires, base radios, satellites or Asynchronous Transfer Mode (ATM) networks.

As is well known, users of communication devices connected to the Internet may surf through a variety of web sites hosted by business enterprises, government entities, educational institutions and the like. Often, such sites offer goods or services for sale that may be purchased electronically by the Internet user (i.e., by performing point-and-click, keystrokes, and the like via the user device). The electronic purchase of goods or services is known as electronic commerce, or e-commerce. As presently known, e-commerce transactions require the customer, having selected item(s) or service(s) for purchase, to enter a credit card number to effect payment. Thereafter, the seller verifies the credit card authorization, delivers the goods or service and obtains payment from the credit card company. The customer pays the credit card company some time later.

A problem that arises is that certain prospective e-commerce customers may not have a credit card yet may wish to purchase goods or services on the Internet. These customers may include, for example, minors, persons from cash-based economies, persons who are not likely to pass credit checks or persons who disfavor credit cards. This is a huge potential market that is presently untapped by e-commerce merchants. To tap this market, it would be desirable for network-based merchants to offer “prepaid” service to such customers, such that the customers from all walks of life may pay up front for a certain level of goods or services (rather than paying a bill some time later as in conventional e-commerce transactions), giving the customer the opportunity to perform e-commerce transactions until such time as the credit level in the prepaid account is deleted.

One example of such system is described and claimed in related application Bartter 1-20-2-1-1-1, titled “Network-Based Electronic Commerce System Incorporating Prepaid Service Offerings.” This system builds upon and is compatible with pre-existing prepaid service offerings for voice telecommunications, allowing prepaid customers to perform telephony and other service transactions (including Internet-based prepaid purchases and/or point-of-sale-based prepaid purchases for any product or service) without requiring credit cards or contracts and without receiving monthly bills.

In a prepaid e-commerce system of the above-described type (or generally in any prepaid system), there is a need for external systems to credit or replenish subscriber accounts from time to time as subscriber balances become diminished. The present invention is directed to addressing this need.

### SUMMARY OF THE INVENTION

The present invention provides methods for recharging or replenishing subscriber accounts in an intelligent network-based e-commerce system.

In one embodiment, there is provided a method of replenishing a subscriber account using a credit or debit card. The method begins with an end user sending a recharge request to a client application. The recharge request is a request to credit a prepaid account of the electronic commerce system a recharge amount. The recharge request includes information comprising the recharge amount, an identifier of the prepaid account, and indicia of one of a credit card and/or debit card for funding the recharge amount. Responsive to the recharge request, the client application sends a query to a gateway server including the information. The gateway server sends the information to a service control point (SCP), which determines validity of the account and authorization to fund the recharge amount using the credit/debit card.

If the prepaid account is valid and the recharge amount is authorized, the SCP credits the recharge amount to the prepaid account and sends an acknowledgment to the gateway server. The gateway server forwards the acknowledgment to the client application and the client application informs the end user of the successful transaction. If the prepaid account is not valid or the recharge amount is not authorized, the SCP sends a negative acknowledgment to the gateway server, the gateway server forwards the negative acknowledgment to the client application and the client application informs the end user of the unsuccessful transaction.

In another embodiment, there is provided a method of replenishing a subscriber account using a scratch card. The method begins with an end user sending a recharge request to a client application. The recharge request is a request to credit a prepaid account of the electronic commerce system a recharge amount. The recharge request includes information comprising the recharge amount, an identifier of the prepaid account, and indicia of a scratch card for funding the recharge amount. Responsive to the recharge request, the client application sends a query to a gateway server including the information. The gateway server sends the information to a service control point (SCP), which determines validity of the account and validity of the scratch card. In one embodiment, the SCP determines validity of the scratch card by querying a recharge card management system (RCMS).

If the account and scratch card are valid, the SCP credits the recharge amount to the prepaid account and sends an acknowledgment to the gateway server. The gateway server forwards the acknowledgment to the client application and the client application informs the end user of the successful transaction. If the account or scratch card are not valid, the SCP sends a negative acknowledgment to the gateway server, the gateway server forwards the negative acknowledgment to the client application and the client application informs the end user of the unsuccessful transaction.

### BRIEF DESCRIPTION OF THE DRAWINGS

The foregoing and other advantages of the invention will become apparent upon reading the following detailed description and upon reference to the drawings in which:

FIG. 1 is a block diagram of an intelligent network-based e-commerce system that incorporates prepaid service offerings according to the present invention;

FIG. 2 is a flowchart of a method for recharging a subscriber account using a credit card or debit card in an intelligent network-based electronic commerce system; and

FIG. 3 is a flowchart of a method for recharging a subscriber account using a scratch card in an intelligent network-based electronic commerce system.

### DESCRIPTION OF THE PREFERRED EMBODIMENT(S)

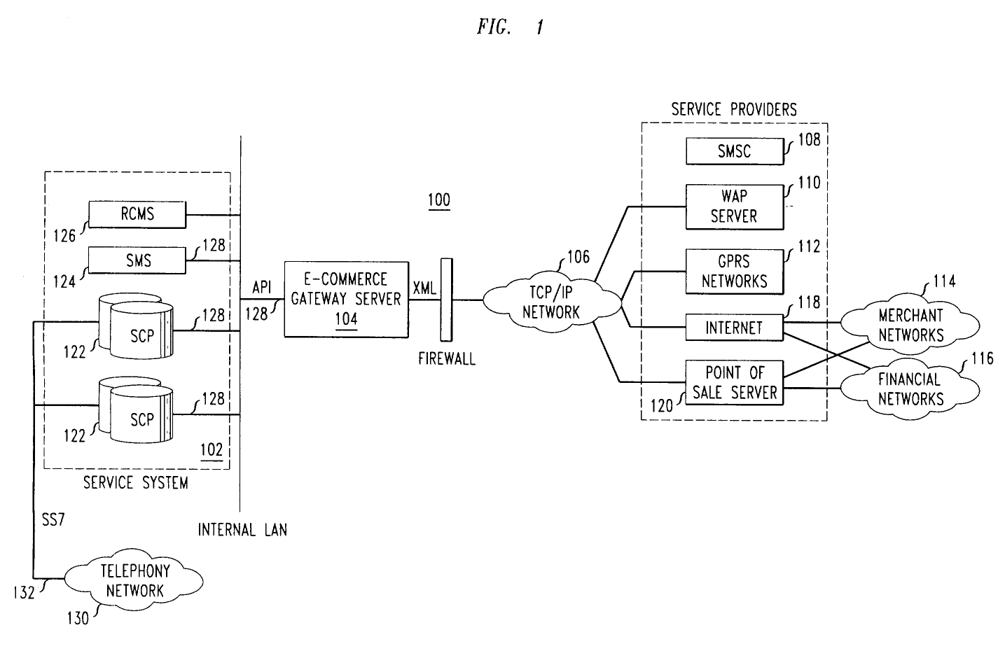

Turning now to the drawings and referring initially to FIG. 1, there is shown an intelligent network-based e-commerce system 100 according to one embodiment of the present invention. The e-commerce system 100 comprises a service system 102 connected via a gateway server 104 to a packet network 106 (as shown, a TCP/IP network). The packet network 106 interfaces to various e-commerce merchants and/or services (hereinafter termed “service providers”) that may request access to the service system 102 to perform e-commerce transactions. As shown, the service providers include short message service center (“SMSC”) 108, Web Application Platform (WAP) server 110, General Packet Radio Service (GPRS) networks 112, merchant networks 114 and financial networks 116. As shown, the merchant and financial networks 114, 116 access the service system via the Internet 118 or “point of sale” servers 120. Subscribers of the prepaid e-commerce service (i.e., e-commerce customers) may also access the service system via the Internet 118 or point of sale servers 120.

As will be appreciated, the service providers shown in the e-commerce system 100 do not represent an exhaustive list but generally depict a wide range of e-commerce options available to prepaid customers. The types of services that may be available from the service providers include, for example but not limitation, purchases of goods, movie tickets, telephony services, short message service, WAP service, Internet usage, Internet gaming and music or file uploads/downloads. The customer interacts with the service provider with communication devices (not shown) including but not limited to mobile phones, wireless hand-held devices, kiosks, point-of-service clients, Internet screens, etc.

The service system 102 comprises a plurality of Service Control Points (“SCPs”) 122, a service manager system (“SMS”) 124 and a recharge card management system (“RCMS”) 126. Each of these devices includes respective processors and memory (not shown) for effecting certain transactions relating to the services and capabilities of the service system 102.

The SCPs 122 maintain subscriber accounts and serve in the role of a “portal” to subscriber balance(s), thereby enabling service providers to access and modify subscriber account(s) in the course of e-commerce transactions. In one embodiment, a mated pair of SCPs is provided for purposes of redundancy; wherein for each subscriber, there is a designated “primary” SCP and “secondary” SCP. The SCPs are connected to the gateway server 104 via links 128 (as shown, Application Programmable Interface (API) link(s)). One example of API link is Lightweight Directory Access Protocol (LDAP) developed by Lucent Technologies. The SCPs 122 are further connected to a telephony network 130 via links 132 (as shown, SS7 telephony signaling links) such that the service system 102 may support prepaid voice service for users of the telephony network 130 in addition to the services provided by the network-based service providers 108-120. The telephony network 130 may comprise a wired or wireline network using SS7 links.

The SMS 124 performs provisioning, administration and management functions for the service system 102. Generally, this includes generating and/or maintaining subscriber and service information associated with the service system 102 and downloading the information as required to the SCPs 122. The SMS 124 communicates with the SCPs via an API link 128 or TCP/IP interface (not shown) (e.g., CORBA over TCP/IP). More specifically, duties of the SMS 124 include: establishing new subscriber accounts and/or maintaining existing accounts (including subscriber IDs, credit amounts); mapping subscriber IDs to primary/secondary SCPs; identifying various attributes of the subscribers (for example, age, sex, language type, currency type, usage data, service preferences and/or restrictions); and generating comprehensive reports of account/usage information.

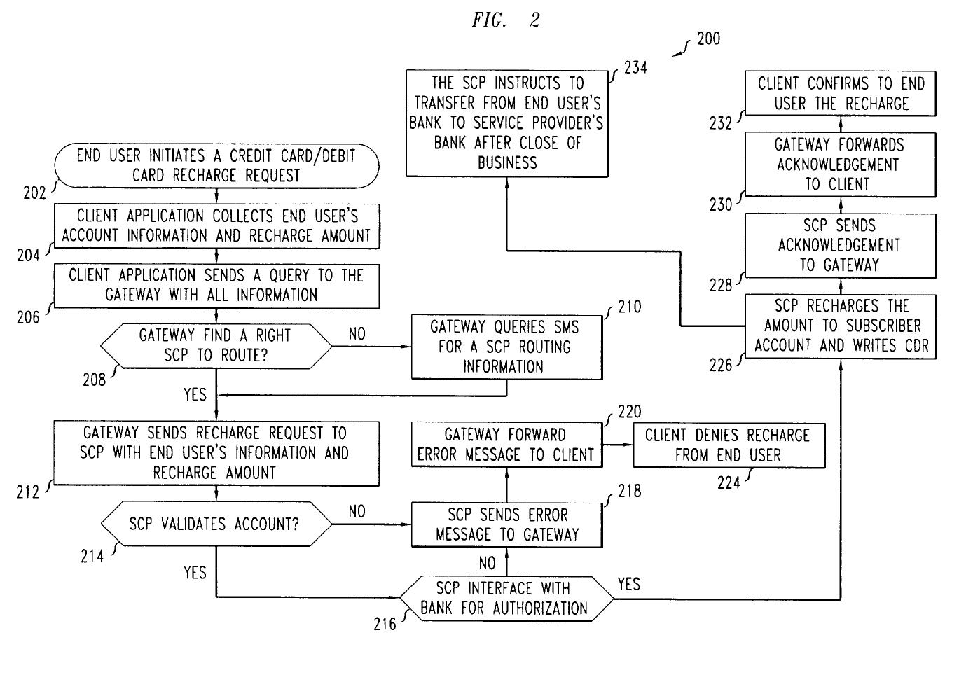

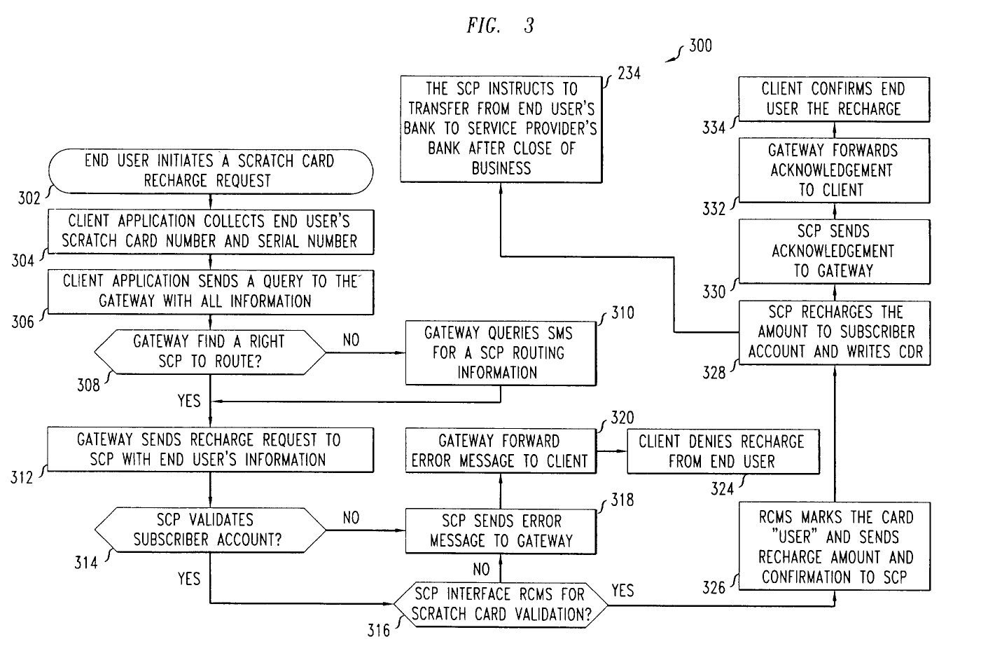

The RCMS 126 facilitates periodic recharging or replenishing of the subscriber accounts and communicating the recharging information as required to the SMS 124. The RCMS 124 communicates with the SCPs 122 and SMS 124 via an API link 128 or TCP/IP interface (not shown). As will be described in greater detail later in this document, transactions supported by the RCMS in conjunction with the SCPs and/or SMS include crediting subscriber accounts using a credit card (FIG. 2) and a scratch card (FIG. 3).

The gateway server 104 serves as an interface for service providers and/or subscribers to access the service system 102 (and hence, to access prepaid subscriber accounts) to facilitate e-commerce transactions. The gateway server 104 is a functional element that may reside in one or more physical devices. As shown, all network-based service providers 108-120 access the gateway server via the TCP/IP network 106, whereas the telephony network 130 may access the service system 102 directly, using SS7 protocol. The TCP/IP network 106 is adapted for transporting IP messages (or “datagrams”) via one or more routers (not shown). As will be appreciated, alternative configurations are possible. For example, certain service providers 108-120 may interface directly to the gateway server 104 (i.e., via links/networks other than the TCP/IP network 106).

In one embodiment, messages are communicated between the gateway server and service providers 108-120 and/or subscribers using eXtensible Markup Language (XML). XML is the universal format for structured documents and data on the Web. The XML protocol thus gives service providers and subscribers a great deal of flexibility to access the subscriber account information. For example, service providers or subscribers may access the account information from Internet screens, point-of-sale computing devices, wireless devices or generally any device that is capable of communicating with the gateway server 104 via XML protocol. As will be appreciated, protocols other than XML could be used.

In one embodiment, the gateway server 104 performs three primary functions: protocol conversion for e-commerce operations, subscriber mapping to the SCP(s) and operations logging. The protocol conversion function comprises translating XML queries or transaction requests from service providers or subscribers into the API format supported by the service system 102; and conversely, translating API responses of the service system 102 to XML format for delivery to service providers 108-120 or subscribers. The mapping function comprises maintaining a database identifying the primary and secondary SCP for each subscriber for which an e-commerce transaction has been performed. For subscribers who are first-time users of the e-commerce system, the gateway server queries the SMS 124 to identify the primary and secondary SCP and thereafter maintains the information in a mapping table/database. Thereafter, upon receiving a query or transaction relating to a particular subscriber, the gateway server consults the mapping table to determine the primary and secondary SCP (hence, freeing the service provider and subscribers from such burden). Optionally, the gateway server may periodically delete mappings of subscribers who are inactive for a period of time. Moreover, the gateway server may periodically re-identify primary and secondary SCPs if/when failures occur in the originally identified primary or secondary SCPs. In one embodiment, if there is an automatic provisioning of new entries of subscribers on the gateway server via SMS (i.e, SMS automatically provisions new subscribers in the mapping table at the gateway), the gateway will return error message to the client systems when receiving an unrecognized subscriber ID in incoming requests. The logging function logs all requests and indicates the outcome (i.e., success or failure) of each request.

In one embodiment, the gateway server includes processor and memory (not shown) operable to support a subscriber base of one million customers. This performance level can be scaled/tuned depending on the scope of the e-commerce system 100.

FIG. 2 is a flowchart of a method for an end user (i.e., subscriber) to recharge a subscriber account using a credit card or debit card in an intelligent network-based electronic commerce system according to one embodiment of the invention. The steps of FIG. 2 are implemented, where applicable, using stored software routines within the gateway server 104, SCP(s) 122, SMS 124 or RCMS 126 of the e-commerce system 100. For purposes of the present example, it is presumed the end user is accessing the e-commerce system via the Internet 118. Alternatively, as will be appreciated, the end user might access the system via wireless device/network.

At step 202, the end user clicks (e.g., on a web page icon) and executes keystrokes as may be appropriate to initiate a credit card or debit card recharge request. At step 204, a client application (i.e., e-commerce software) collects information relevant to the recharge request such as user ID, credit/debit card number, charge amount, PIN number, expiration date and the like. The client application may reside in a server operated by a merchant or service provider 108-120 (e.g., Western Union). At step 206, the client application sends a query to the gateway server 104 including the relevant information. In one embodiment, the query is in XML format.

At step 208, the gateway server 104 determines whether it is able to identify primary and/or secondary SCP(s) to which the request is to be routed. In one embodiment, this comprises consulting its mapping table to determine whether subscriber data is found corresponding to the subscriber ID identified in the request. In one embodiment, this subscriber data includes an identification of primary or secondary SCP(s) of the e-commerce system. As will be appreciated, different service providers may have different ID(s) or account codes for the same subscriber depending on the different service providers naming/numbering schemes. For example, for a mobile wireless service provider, the subscriber ID could be a Mobile Station International Subscriber Directory Number (MSISDN) or Mobile Directory Number (MDN) depending on the service provider's network. In one embodiment, the mapping table includes a mapping of multiple ID(s) to individual subscriber(s), where applicable, to accommodate different subscriber ID(s)/account codes.

If SCP routing data is not found, the gateway server queries the SMS at step 210 to determine whether the SMS 124 can identify a primary and/or secondary SCP corresponding to the subscriber ID. In one embodiment, for example, the mapping table of the gateway server does not identify primary or secondary SCPs for first-time users. In such case, the gateway server may query the SMS to identify the primary and secondary SCP for the first-time user. The gateway server thereafter maintains the information in its mapping table.

If the gateway server is able to successfully identify the primary and/or secondary SCP, either at step 208 or in response to querying the SMS at step 210, the gateway server sends at step 212 a recharge request message to the designated SCP(s). In one embodiment, the recharge request is in API format and includes parameters such as subscriber ID, credit/debit card number, charge amount, PIN number, expiration date and the like.

At step 214, the acting SCP attempts to validate the subscriber account. In one embodiment, this comprises determining whether an account corresponding to the subscriber ID exists, and if so, whether the account is enabled or disabled. If the account does not exist or is disabled, the SCP returns an error message to the gateway server at step 218 indicating the account is not valid. The gateway server forwards the error message to the client at step 220 and the client denies the recharge request from the end user at step 224.

If the account is valid, the SCP attempts to obtain authorization from the end user's financial institution (i.e., the credit/debit card issuer) to charge the requested amount. Alternatively, authorization from the financial institution may be obtained by the gateway server or by the client application. If authorization is not obtained, the SCP returns an error message to the gateway server at step 218. The gateway server forwards the error message to the client at step 220 and the client denies the recharge request from the end user at step 224. Otherwise, if authorization for the charge is obtained, the SCP credits (or “recharges”) the amount to the subscriber account and records the transaction into a Call Detail Record (CDR) at step 226 and sends an acknowledgment message to the gateway server at step 228. The gateway server forwards the acknowledgment to the client at step 230 and the client confirms the recharge with the end user at step 232.

At step 234, to effect payment to the e-commerce service provider, the SCP sends a message to the end user's financial institution (i.e., the issuer of the credit/debit card) instructing it to transfer funds corresponding to the charge amount from the subscriber account to the e-commerce service provider's bank. Generally, such payment occurs some time after completion of the transaction (e.g., at close of business) as is customary for banking transactions.

FIG. 3 is a flowchart of a method for an end user (i.e., subscriber) to recharge a subscriber account using a scratch card in an intelligent network-based electronic commerce system according to one embodiment of the invention. The steps of FIG. 3 are implemented, where applicable, using stored software routines within the gateway server 104, SCP(s) 122, SMS 124 or RCMS 126 of the e-commerce system 100. For purposes of the present example, it is presumed the end user is accessing the e-commerce system via the Internet 118. Alternatively, as will be appreciated, the end user might access the system via wireless device/network.

At step 302, the end user clicks (e.g., on a web page icon) and executes keystrokes as may be appropriate to initiate a scratch card recharge request. A scratch card is a card/token having a pre-specified value (e.g., $10, or $25) that enables a purchaser to obtain that value of services from a service provider at some future time. For example, a scratch card may allow for $10 of wireless service from a telecommunications service provider. Typically, when the card owner desires to access the service, he or she is prompted to enter a PIN number or scratch card number and the card is validated by the service provider before providing the service.

At step 304, a client application (i.e., e-commerce software) collects information relevant to the recharge request such as user ID and scratch card number. The charge amount is known (or can be determined) from the scratch card number. The client application may reside in a server operated by a merchant or service provider (e.g., Western Union). At step 306, the client application sends a query to the gateway server 104 including the relevant information. In one embodiment, the query is in XML format.

At step 308, the gateway server 104 consults its mapping table to determine primary and/or secondary SCP(s) associated with the subscriber ID; and if necessary, the gateway server 104 queries the SMS at step 310, substantially as described in relation to FIG. 2. If the gateway server is able to successfully identify the primary and/or secondary SCP, either at step 308 or in response to querying the SMS at step 310, the gateway server sends at step 312 a recharge request message to the designated SCP(s). In one embodiment, the recharge request is in API format and includes parameters such as subscriber ID and scratch card number.

At step 314, the acting SCP attempts to validate the subscriber account. In one embodiment, this comprises determining whether an account corresponding to the subscriber ID exists, and if so, whether the account is enabled or disabled. If the account does not exist or is disabled, the SCP returns an error message to the gateway server at step 318 indicating the account is not valid. The gateway server forwards the error message to the client at step 320 and the client denies the recharge request from the end user at step 324.

If the account is valid, the SCP attempts to obtain scratch card validation from the RCMS 126. In one embodiment, the RCMS maintains a database of scratch card numbers and associated amounts and indicia of whether the card has been used (and hence, no longer valid) or unused. The RCMS consults the database to validate (or not validate) the card. Alternatively, scratch card validation might be obtained by the gateway server or by the client application. If validation is not obtained, the SCP returns an error message to the gateway server at step 218. The gateway server forwards the error message to the client at step 220 and the client denies the recharge request from the end user at step 224.

If validation of the card is obtained, the RCMS at step 326 marks the card “used” (so as to be invalid for later use) and sends the recharge amount and confirmation to the SCP. The SCP credits (or “recharges”) the amount to the subscriber account and records the transaction into a Call Detail Record (CDR) at step 328 and sends an acknowledgment message to the gateway server at step 330. The gateway server forwards the acknowledgment to the client at step 332 and the client confirms the recharge with the end user at step 334.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. In an electronic commerce system containing one or more service control points (SCPs) operably connected to a gateway device, the SCPs maintaining prepaid subscriber accounts for one or more subscribers, a method comprising:
sending, from an end user to a client application, a recharge request, the recharge request defining a request to credit a prepaid account of the electronic commerce system a recharge amount, the recharge request including information comprising the recharge amount, an identifier of the prepaid account, and indicia of one of at least one of a credit card and debit card for funding the recharge amount;
sending, from the client application to the gateway server, a recharge query message including the information;
determining, by the gateway server, a primary SCP of the one or more SCPs;
sending, from the gateway server to the primary SCP, a recharge request message including the information;
determining, by the primary SCP, a validity status of the prepaid account;
determining, by the primary SCP, an authorization to fund the recharge amount using the at least one of the credit card and debit card; and
if the prepaid account is valid and the recharge amount is authorized, crediting the recharge amount to the prepaid account.

2. The method of claim 1, wherein the step of crediting the recharge amount to the prepaid account comprises adding, by the primary SCP, the recharge amount to an account balance of the prepaid account, yielding an updated account balance.

3. The method of claim 1, wherein the step of crediting the recharge amount to the prepaid account defines a successful recharge transaction, the method further comprising:
recording the transaction by the primary SCP;
sending an acknowledgment message from the primary SCP to the gateway server;
sending an acknowledgment message from the gateway server to the client application; and
confirming the successful recharge transaction with the end user.

4. The method of claim 3, further comprising:
sending, from the primary SCP to a first financial institution having issued the one of at least one of a credit card and debit card to the end user, a request to transfer funds corresponding to the recharge amount to a second financial institution associated with the electronic commerce system.

5. The method of claim 1 comprising, if either the prepaid account is invalid or the recharge amount is not authorized, thereby defining an unsuccessful recharge transaction,
sending a negative acknowledgment message from the primary SCP to the gateway server;
sending a negative acknowledgment message from the gateway server to the client application; and
informing the end user of the unsuccessful recharge transaction.

6. In an electronic commerce system containing one or more service control points (SCPs) operably connected to a gateway device, the SCPs maintaining prepaid subscriber accounts for one or more subscribers, a method comprising:
sending, from an end user to a client application, a recharge request, the recharge request defining a request to credit a prepaid account of the electronic commerce system a recharge amount, the recharge request including information comprising the recharge amount, an identifier of the prepaid account, and indicia of a scratch card for funding the recharge amount;
sending, from the client application to the gateway server, a recharge query message including the information;
determining, by the gateway server, a primary SCP of the one or more SCPs;
sending, from the gateway server to the primary SCP, a recharge request message including the information;
determining, by the primary SCP, a validity status of the prepaid account;
determining, by the primary SCP, a validity status of the scratch card; and
if the prepaid account and scratch card are valid, crediting the recharge amount to the prepaid account.

7. The method of claim 6, wherein the step of crediting the recharge amount to the prepaid account comprises adding, by the primary SCP, the recharge amount to an account balance of the prepaid account, yielding an updated account balance.

8. The method of claim 6, wherein the electronic commerce system includes a recharge card management system (RCMS) operably coupled to the primary SCP, the RCMS maintaining validity information associated with one or more scratch cards, the step of determining the validity status of the scratch card comprising:
sending, from the primary SCP to the RCMS, a message requesting the validity status;
determining, by the RCMS, the validity status; and
sending, from the RCMS to the primary SCP, a message including indicia of the validity status.

9. The method of claim 8, wherein the step of crediting the recharge amount to the prepaid account defines a successful recharge transaction, the method further comprising:
adjusting, by the RCMS, the validity information to indicate the scratch card may no longer be used;
recording the transaction by the primary SCP;
sending an acknowledgment message from the primary SCP to the gateway server;
sending an acknowledgment message from the gateway server to the client application; and
confirming the successful recharge transaction with the end user.

10. The method of claim 6 comprising, if either the prepaid account or scratch card is invalid, thereby defining an unsuccessful recharge transaction, sending a negative acknowledgment message from the primary SCP to the gateway server;
sending a negative acknowledgment message from the gateway server to the client application; and
informing the end user of the unsuccessful recharge transaction.
